(19) United States
(12) Patent Application Publication
(10) Pub. No.: US 2002/0059158 A1
(43) Pub. Date: May 16, 2002

(54) Determination of population safe dosage levels of pharmaceutically active substances

(75) Inventors: Arnold J. Goldman, Jerusalem (IL); Lewis Rosen, Jerusalem (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Insyst Ltd.

(21) Appl. No.: 09/998,189

(22) Filed: Dec. 3, 2001

Related U.S. Application Data
(63) Continuation-in-part of application No. 09/633,824, filed on Aug. 7, 2000.
(63) Continuation-in-part of application No. 09/588,681, filed on Jun. 7, 2000.
(63) Continuation-in-part of application No. 09/731,978, filed on Dec. 8, 2000.
(60) Provisional application No. 60/313,823, filed on Aug. 22, 2001.

(30) Foreign Application Priority Data
Oct. 31, 1999 (IL) 132663

(51) Int. Cl. G06F 17/00

(52) U.S. Cl. 706/45; 706/54

(57) ABSTRACT

A method and system for reducing a probability of a negative outcome of applying over a population, of a pharmaceutically active product, the method comprising: obtaining data including dosage data of applications and corresponding results, and analytically processing said data to relate dosage data to subgroupings within said population, thereby to arrive at a safe dosage recommendation of said pharmaceutically active product for at least one of said subgroupings, said safe dosage level recommendation being arrived at to minimize said probability of a negative outcome.

### FIELD AND BACKGROUND OF THE INVENTION

The present invention relates to the determination of safe dosage levels of pharmaceutically active substances, and to an apparatus for the same.

The process of developing drugs is long and expensive. It is estimated that a new drug application will cost $400M to $500M or more in today's terms, spent over the ten to twelve years prior to regulatory approval. Large pharmaceutical companies typically have an ongoing drug development program in which several hundreds or thousands of new chemical entities (NCEs) are investigated each year. The process includes several sequential stages, starting with chemical assays, lab tests with specific tissue samples, animal tests, and continuing through to clinical trials involving humans.

The clinical trial stage is itself divided into three phases, each involving steadily larger samples of participants. Phase I focuses on demonstrating safety. Phase II on demonstrating efficacy against the illness being treated. Following Phase II, the drug is subject to much wider efficacy and safety testing in Phase III, usually involving several thousand patients with the pathology being treated. At the end of Phase III, the pharmaceutical company or biotech company (henceforth, “pharmaceutical company” will refer to both pharmaceutical and biotech companies) typically submits an application to the US Federal Drug Administration or other regulatory authorities (henceforth, “regulatory authorities”) seeking approval to market the drug.

Once a drug is approved and general use begins, safety monitoring of patients using the drug generally occurs. This stage is referred to as Phase IV and sometimes its results lead to a drug being withdrawn from the market or its user populations significantly narrowed by the regulatory authorities. This occurs when Phase IV results show an unacceptably high incidence of adverse drug impacts, and sometimes death, associated with user experience with the drug.

At each stage of the drug development process, some drugs are dropped based on unfavorable test results, with the percentage of tested drugs that are dropped being particularly high at earlier stages of the process. As a result, relatively small numbers of drugs reach the human trials stage, and an even smaller number are submitted to the regulatory authorities for approval.

Of all the drugs entering Phase III trials, about 85% are eventually submitted for approval, with the remaining 15% being voluntarily withdrawn before the submission stage. About 70% of the drugs submitted (or about 60% of all drugs going into Phase III) receive the approval of the FDA, the US regulatory authority.

Pharmaceutical companies currently undertake and present to regulatory authorities conventional statistical analysis of patient results obtained during all Phase I, II, and III clinical trials for the drug. These statistical analyses include hypothesis testing, analysis of variance, and other techniques.

The general approach to drug dosing is worth noting here as an important element of the prior art. When submitting a new drug for approval, pharmaceutical companies normally propose a single dose for all patients. In a minority of instances, they propose a few alternative doses for particular segments of the target user population. The preference for uniform dosages is based on trying to minimize the number of pill doses to reduce manufacturing costs and to simplify the physician's task in determining appropriate dosages for specific patients.

Although the percentage of drugs that fail at Phase III is lower than at earlier phases of the drug development process, the consequences of a failed drug at this stage can be critical to the company because the anticipated revenues from the drug may already be included in investor valuations of the pharmaceutical company. Perhaps even more critical is the risk that a drug that has been approved for marketing and is already being sold will subsequently be withdrawn or will experience a significant narrowing of the user population for the drug due to adverse drug impacts. Such drugs and their revenues unquestionably influence investor valuations of the pharmaceutical company.

For a small pharmaceutical company the withdrawal of a major drug and associated loss of revenues could threaten the company's continued existence. Even for large pharmaceutical companies, the withdrawal of a “blockbuster” drug can have strategically negative impacts on a company. The unexpected rejection of one or more drugs after Phase III trials, or the unexpected withdrawal or significant narrowing of the user population of a drug generating or expected to generate significant revenues, can lead to sharp deterioration in the company's current and anticipated future profitability, resulting in a major decline in company valuation, possibly threaten the viability of the company as an independent entity, and endanger the position of the current CEO and other senior managers.

Prior to this invention, insurance (“clinical trials insurance”) is provided to organizations operating clinical trials against claims from participating patients who claim to have been negatively affected by the drug. Similarly, after a drug is approved and in the market, insurance is provided (“product liability insurance”) against claims from persons who claim to have been negatively affected by the drug. While both kinds of insurance protect against losses associated with these damage claims, the former does not provide for the recovery of the Phase III drug development costs if a new drug is rejected by regulatory authorities, and the latter does not provide protection against the loss of revenues that would result for a specific number of years for a pharmaceutical company if the emergence of adverse drug effects causes the drug to be withdrawn from the market or its use significantly narrowed.

In today's environment where these risks are relatively high and the financial impacts of these negative outcomes may be substantial, the premiums that insurance companies would charge for such insurance would be prohibitive.

Therefore, it would be highly advantageous for pharmaceutical companies to be able to obtain insurance against these risks at premium costs that would make such insurance economically attractive.

Today, a drug rejected by regulatory authorities, or one withdrawn from the market due to adverse effects, has little if any value, mainly because the drug produces no future revenue stream. This is the case even though significant intellectual property rights have been created for such drugs. It would be highly advantageous to salvage some of the value associated with these drugs, their intellectual property and accumulated data.

### SUMMARY OF THE INVENTION

According to a first aspect of the present invention there is provided a method of reducing a probability of a negative outcome over a population, of a pharmaceutically active product, the method comprising:

obtaining data including dosage data of applications and results of applying said product over a population,

analytically processing said data to relate dosage data to subgroupings within said population, thereby to arrive at a safe and efficacious dosage recommendation of said pharmaceutically active product for at least one of said subgroupings, said safe dosage level recommendation being arrived at to minimize said probability of a negative outcome.

Preferably, said obtaining data comprises obtaining data of standard pharmaceutical product tests.

Preferably, said obtaining data comprises obtaining data of non-standard pharmaceutical product tests.

Preferably, said obtaining data comprises obtaining historical use data of said product. Optionally, it also comprises obtaining data of similar products, and optionally again obtaining general or specific data for similar population subgroupings.

The method preferably comprises providing dosage recommendations respectively for a plurality of said population subgroupings.

Preferably, obtaining data comprises monitoring blood serum levels of members of said population.

The method preferably comprises using a probability threshold to select said safe dosage recommendation.

Preferably, said probability threshold is an actuarially verifiable probability threshold.

Preferably, said analytically processing comprises use of at least one technique selected from the group consisting of:

a knowledge tree, said knowledge tree including interconnection cells describing qualitative relationships between inputs and outputs,

a quantitative model for the description of the relationship between the inputs and the outputs, and

a decision making optimization technique.

According to a second aspect of the present invention there is provided a method of reducing a probability of a negative outcome over a population, of a pharmaceutically active product, the method comprising:

obtaining data including dosage data of applications and results of applying said product over a population,

analytically processing said data to relate dosage data to subgroupings within said population, thereby to arrive at an actuarially robust safe and efficacious dosage recommendation of said pharmaceutically active product for at least one of said subgroupings, said safe dosage level recommendation being arrived at to minimize said probability of a negative outcome.

Preferably, said analytically processing comprises use of at least one technique selected from the group consisting of:

a knowledge tree, said knowledge tree including interconnection cells describing qualitative relationships between inputs and outputs, a quantitative model for the description of the relationship between the inputs and the outputs, and

a decision making optimization technique.

According to a third aspect of the present invention there is provided apparatus for reducing a probability of a negative outcome over a population, of a pharmaceutically active product, the apparatus comprising:

an input for receiving data including dosage data of applying of said product and results of applying said product over a population,

an analytical processor for analytically processing said data to relate dosage data to subgroupings within said population, thereby to arrive at a safe and efficacious dosage recommendation of said pharmaceutically active product for at least one of said subgroupings, said safe dosage level recommendation being arrived at to minimize said probability of a negative outcome.

Preferably, said analytical processor is further operable to provide dosage recommendations respectively for a plurality of said population subgroupings.

Preferably, said analytical processor comprises a thresholder to obtain a probability threshold to select said safe dosage recommendation.

Preferably, said probability threshold is an actuarially verifiable probability threshold.

Preferably, said analytical processor is adapted to use at least one technique selected from the group consisting of:

a knowledge tree, said knowledge tree including interconnection cells describing qualitative relationships between inputs and outputs,

a quantitative model for the description of the relationship between the inputs and the outputs, and

a decision making optimization technique.

The apparatus may comprise a memory unit for registering ownership information relating to said active pharmaceutical product, thereby to facilitate ownership transfer in case of occurrence of said negative outcome. Thus salvage of a failed drug is easily implemented.

The apparatus may be implemented as software or hardware as deemed appropriate by the skilled user.

Use of the present invention to provide safe dosage levels on a population subgroup level, in conjunction with the issuance of such insurance coverage that will result in improved efficacy and safety of drugs, such that the risk of regulatory failure would be reduced and the risk of an approved drug being withdrawn or having its user population significantly narrowed after it is in the market would be reduced. As a result of these risk reductions, the insurance company would be able to provide insurance economically, and the premiums would be such that pharmaceutical companies would benefit by buying such insurance.

The present invention successfully addresses the shortcomings of the presently known configurations by providing a method and system for reducing the risk that a drug in Phase III clinical trials will be rejected by regulatory authorities and the risk that an approved drug will be withdrawn or have its use significantly narrowed by regulatory authorities due to the emergence of adverse side effects, and facilitating the offering of insurance against these risks to pharmaceutical companies. Additionally, there will be a system for transferring the intellectual property and the data associated with a failed drug from the pharmaceutical company that developed the drug to a benefactor stipulated by the insurance company, which benefactor would be able to remarket the drug, after receiving regulatory approval for a restricted user population, generating an ongoing revenue stream from sales of the drug. The insurance company would receive some combination of upfront license fee and/or ongoing royalties from the benefactor.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flow chart of prior art regarding analysis of data for a drug compound;

FIG. 2 is a flowchart of a method for analysis of data for a drug compound to enhance safety/efficacy prospects;

FIG. 3-is an illustration of a Knowledge Tree used for logical mapping of inputs and outputs;

FIG. 4-is a graphic representation of a optimization process;

FIG. 5-is a graphical representation of optimization process applied to the choice of optimal dosage; and

FIG. 6 is a simplified block diagram showing an apparatus for providing recommended drug dosage levels for a population or subgroups thereof according to a preferred embodiment of the present invention.

### DESCRIPTION OF THE PREFERRED EMBODIMENTS

The present embodiments relate to a method in the field of risk management related to new drugs and, more particularly, to a method which can be applied to insuring that a drug being tested in Phase III clinical trials will not be rejected by regulatory authorities and for insuring that a drug already approved won't be withdrawn or have its market significantly narrowed due to the incidence of adverse side effects after it is in the market. For drugs already in the market, the method would reduce the incidence of adverse effects of drugs, reducing the likelihood that the drug would be withdrawn or have its market significantly curtailed. In addition to benefiting the pharmaceutical company, reducing the incidence of adverse effects would benefit patients using the drugs and would reduce treatment costs associated with patients hospitalized due to adverse effects of drugs, which is a significant cause of hospitalization and non-hospital morbidity and mortality. Properly used pharmaceutical products have been found to be between the 4^{th} to the 8^{th} largest cause of death in the US.

The present embodiments comprise a method and/or apparatus for reducing the risk that a drug in Phase III clinical trials will fail to receive regulatory approval, and of reducing the risk that an approved drug already in the market will be withdrawn or have its user population significantly narrowed as a result of the emergence of unexpected adverse side effects. The present invention is also used to provide insurance again the occurrence of the abovementioned negative events. Additionally, the present invention will enlarge the amount of data to be studied while the drug is in clinical trials, and while it is in the market, to include periodic patient blood serum and other standard test results and other non-standard test results, and to include historical data relevant to the drug compound being tested or used. Additionally, the use of this present invention will enable finding evidence of favorable efficacy effects and adverse safety effects through more extensive and more effective analysis of population segments than is currently performed. These abovementioned results are achieved through the invention's use of expert knowledge combined with qualitative modeling techniques, its use of discrete segment quantitative techniques, and the analysis of significant patterns linking input variables and output variables. Additionally, the use of this present invention will enable discovering optimal doses for specific population segments, eliminating some adverse safety/efficacy effects through changes in dosage, and excluding from the target user population those population segments where unfavorable safety/efficacy outcomes cannot be eliminated through drug dose optimization.

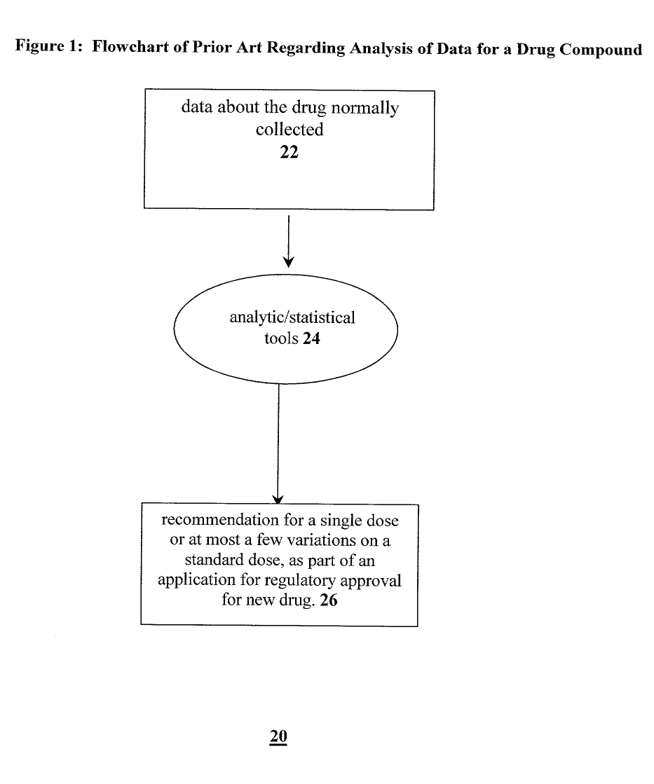

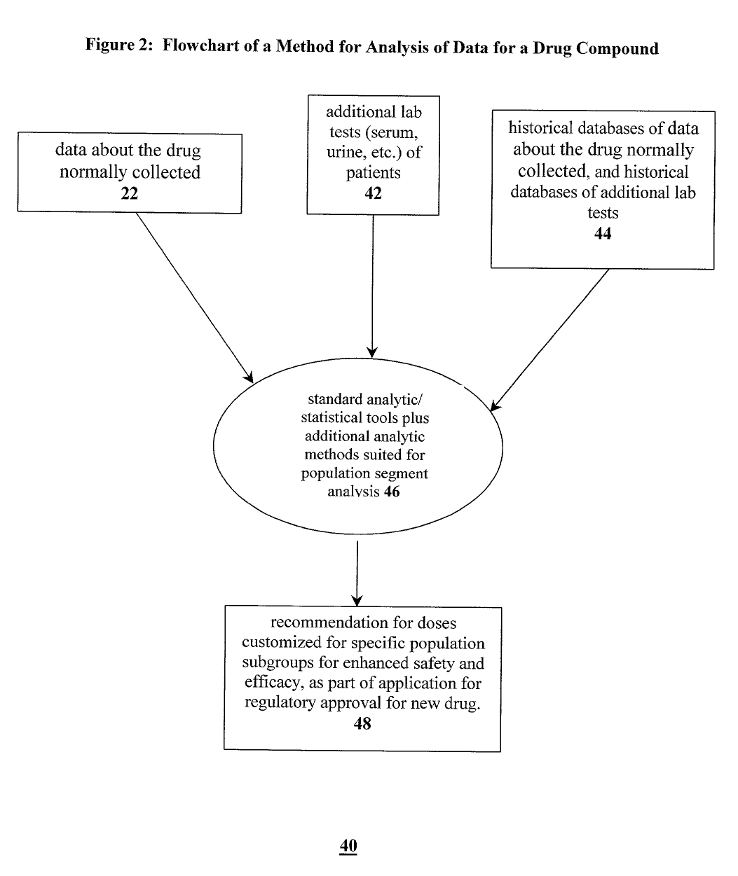

For purposes of better understanding the present invention, as illustrated in FIGS. 2-5 of the drawings, reference is first made to the construction and operation of a conventional (i.e., prior art) data analysis of drug compounds in pre- and post-regulatory approval as illustrated in FIG. 1.

FIG. 1 is a flow chart of prior art illustrating the method 20 of analysis of data for a drug compound. Data about the drug normally collected 22, for example for a drug prior to regulatory approval, include pre-clinical trials laboratory and animal data for the drug compound in addition to Phases I-III patient data. The data are fed into analytical and statistical tools 24 where they are then analyzed and, on the basis of this analysis, a single dose or at most a few variations on a standard dose are then recommended, as part of an application for regulatory approval for a new drug 26. Today, a certain percentage of applications are rejected by regulatory authorities and the drug cannot be marketed.

According to the present embodiments, the occurrence of a negative outcome for a drug in the process of development or one recently introduced to the market, for example, the rejection of a pre-approval drug is reduced. FIG. 2 illustrates the method 40 of risk management related to new drugs. Data about the drug normally collected 22, together with additional lab tests (serum, urine, etc.) of patients 42, including non-standard test results, and historical databases of data about the drug normally collected, and historical databases of additional lab tests 44 are collected. Then standard analytic/ statistical tools plus additional analytic methods suited for population segment analysis 46 are used for analyzing the collected data. Finally, doses are recommended and customized for specific population subgroups for enhanced safety and efficacy, as part of an application for regulatory approval for new drug 48.

This reduction of the occurrence of a negative outcome could facilitate the issuance by insurance companies of insurance policies in order to shift the risk of a failed or restricted drug from the pharmaceutical companies to insurers. According to a preferred embodiment of the present invention, a method of insuring against the occurrence of a negative outcome for a drug developed by a pharmaceutical company is described.

The negative outcome could be any one of the following: failure of the drug to receive regulatory approval; withdrawal of the drug after it is already in the market; and significant narrowing of the drug recipient target population segment after it is already in the market.

Using this method, the potentially disastrous financial and corporate consequences of a drug failure for a pharmaceutical company are replaced with a lower and more predictable ongoing cost of doing business (the insurance premiums). This insurance premium cost to the pharmaceutical company may be partly or fully offset through somewhat higher drug prices. Investors are likely to view the pharmaceutical company as being less risky with this insurance approach because the risk of large unexpected losses has been reduced, and may value pharmaceutical companies more highly, with a higher Price/Earnings ratio, as a result.

For the insurer, because the method reduces the risk of negative outcomes, the premiums from numerous pharmaceutical company clients will cover the payments required for those failures that occur, and will provide the insurer with reasonable profit margin in light of the risk involved.

The benefactors of the risk reduction provided by the method are numerous. Examples of benefactors are the patients themselves of course for whom the occurrence of adverse effects associated with non-optimal drug dosage, HMO's and other health service providers and insurance companies including governmental health insurers would avoid costs incurred in treating patients experiencing avoidable adverse effects of drug use. Additionally, regulatory authorities would benefit by adopting or encouraging the present method by being able to approve new drugs having a higher level of safety and/or efficacy.

When the method is being used to insure against the negative outcome of a drug being rejected by regulatory authorities after Phase III clinical trials, the insurance company requires, as a condition for the insurance, that the pharmaceutical company agrees to the following: (a) to conduct periodic lab tests including tests of patient serum levels, at greater frequency than is currently done; during the clinical trials; (b) to the monitoring of all clinical trials results, included the serum lab data, by an external service provider appointed for that purpose by the insurer; and (c) to propose, in its application to regulatory authorities, a dosage approach characterized by different dosage levels for two or more segments of the population. Also, as a condition for the insurance, all of the Intellectual Property (IP) rights and relevant data associated with the drug will be organized in readily transferable form and then transferred in the case that an insurable event occurs.

In addition to usual data currently analyzed by pharmaceutical companies, according to the method described in this invention, patient serum lab data (to be collected on a more frequent basis than now done during the clinical trials) and relevant historical data for similar drugs and for patients similar to those being tested in the clinical trials, including relevant historical serum lab data, will be included.

In addition to conventional analytical techniques (hypothesis testing, analysis of variance, other statistical techniques) now used by pharmaceutical companies, the insurer will apply a set of additional analytic techniques, which include the following:

a) Building Knowledge Trees (KT) for mapping the relationships between input and output variables;

b) Using a quantitative modeler such as Process Output Empirical Modeler (POEM) in developing quantitative models of the KT relationships between the inputs and the outputs to undertake population subgroup analysis; and

c) Optimization of doses using APC techniques.

These are now discussed in more detail.

(a) Building Knowledge Trees between input and output variables.

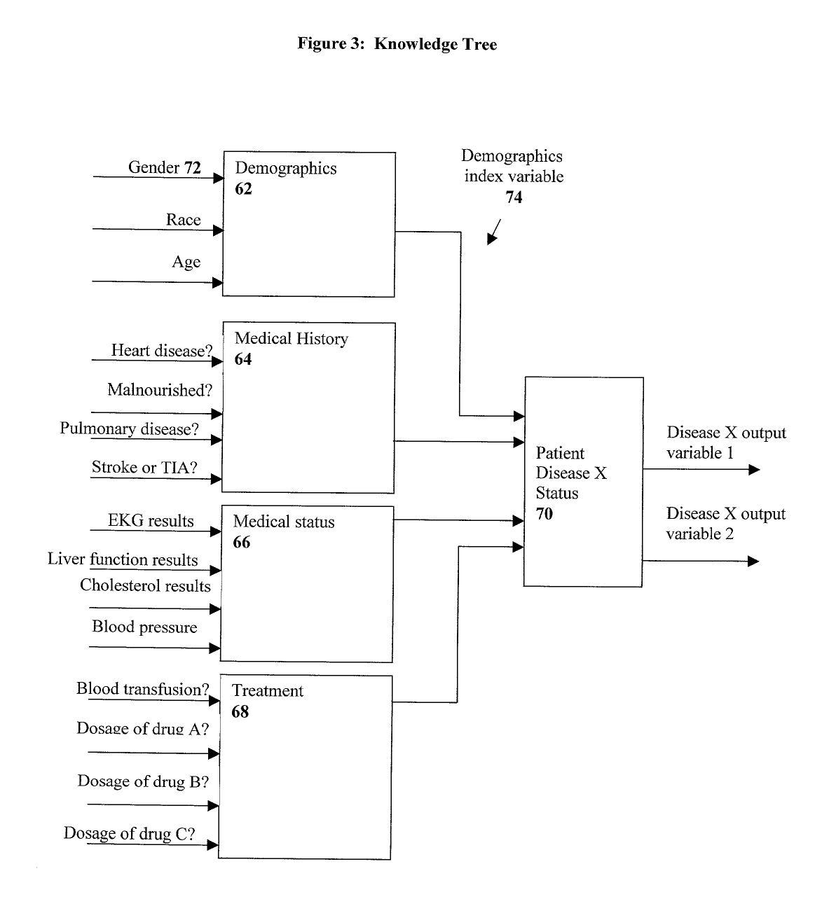

FIG. 3 is an example of the structure of a Knowledge Tree (KT) suitable for the analysis of the drug. A computer program constructs the Knowledge Trees that represent different aspects of safety and efficacy are formed at the beginning of the process, and are modified as new data are obtained and analyzed. The following are examples of KTs used for controlling safety and efficacy. One KT may be a model for an adverse side effect of the proposed drug such as the outcome of liver toxicity and another KT could be for the outcome renal dysfunction, both related to the intake of the drug. An example of a KT for efficacy is for the efficacy of a particular drug, for example a drug for lowering blood pressure. Blood pressure would be its final output whereas among the inputs would be factors such as sex, age, weight and the administration of the drug. Using the KT enables a rapid pinpointing of both safety (risk signals) and on the other hand it could be used to discover efficacy aspects of the proposed drug that would have been difficult or time-consuming otherwise to reveal. In another non-limiting example of the implementation of the Knowledge Tree there are five interrelated cells, Demographics 62, Medical History 64, Medical Status 66, Treatment 68 and Patient Disease “X” Status 70. Each cell has at least one input variable and at least one output variable.

An example of an input to a cell, such as Demographics cell 62, is Gender 72. An example of an output of the same cell 62, is Demographics index variable 74. An output variable, such as Demographics index variable 74 can be an input variable to another cell in this case Patient Disease “X” Status 70.

The KT illustrated in FIG. 3 could be used to show how a change in the dosage of drug A 76, given the value of all other input variables, may impact the disease X output variable 78, which may measure a safety impact, it might be found that with a high dosage of drug A that output variable 78 indicates an adverse safety outcome, while with a medium dosage of drug A there would be no adverse safety outcome.

A Knowledge Tree is a mapping of causal relationships between inputs and outputs. It breaks down a complex process with many input variables and at least one output variable into separate more manageable interrelated processes, each with a smaller, easier to handle, number of variables.

(b) Using Process Output Empirical Modeler (POEM) in developing quantitative models of relationships between the inputs and the outputs. This includes discretization to undertake population segmentation into subgroups and to identify significant patterns by subgroups. POEM is one example of a method that could be used to develop quantitative models of relationships between the inputs and the outputs. Other examples are linear regression, nearest neighbor, clustering, classification and regression tree (CART), chi-square automatic interaction detector (CHAID), decision trees and neural network empirical modeling.

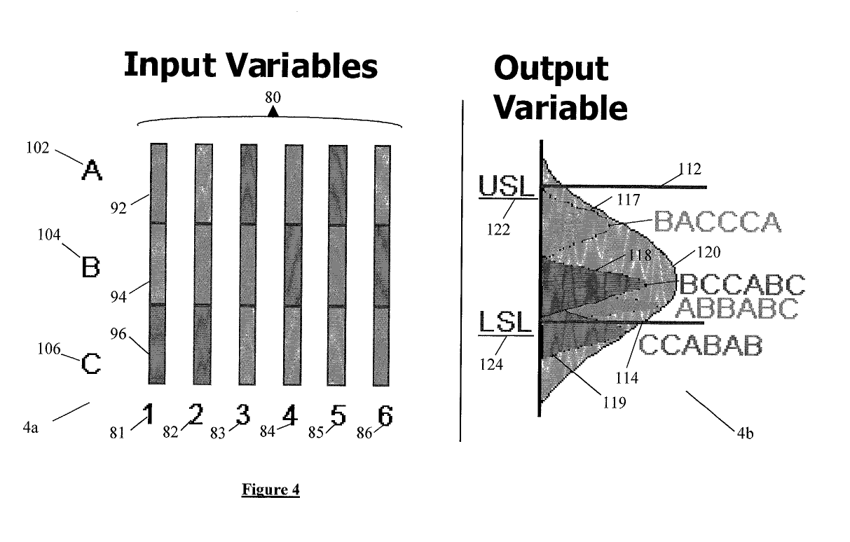

Reference is now made to FIG. 4, which shows patterns of input values that are associated with their own distributions of output variable results. FIG. 4 is a graphic representation of a feed forward optimization process, which is divided into two sections: a set of bars, section 4a; and, a bell-shaped curve, section 4b. The set of bars themselves, generally referenced 80, represent a set of input variables. In the section, six such variables are represented by bars 81-86. In this non-limiting example, each of the six bars 81-86 is in turn divided into three sections.

For example, bar 81 is divided into an upper section 92, a middle section 94 and a lower section 96. These upper, middle, and lower sections (92, 94, and 96; respectively), are also assigned arbitrary letters in order to further facilitate graphic representation of some inputs to the process. The upper section 92 is assigned a letter-A, 102; the middle section 94 is assigned a letter-B, 104; and, the lower section 96 is assigned a letter-C, 106. The letters A, B, and C, are also used to designate the upper, middle, and lower sections, respectively; of bars 82-86. It should be noted that the choice of three letters and three sections is also completely arbitrary and has been made solely in order to simplify the description.

Although the letters A, B, and C are arbitrary, they represent specific subjective value ranges for each of the input variables represented by bars 81-86. The “A” or upper sections of each of the bars 81-86, represent input values greater than some pre-determined upper value for each input. The “C” or lower sections of each of the bars 81-86, represent input values less than some predetermined lower value for each input. The “B” or middle sections of each of the bars 81-86, represent input values within the pre-determined upper and lower values for each input.

In FIG. 4b, a curved line 120 represents a bell-shaped curve. Curved line 120 is intersected by two straight lines: an upper (as depicted in section) line 112; and a lower (as depicted) line 114. Straight lines 112 and 114 are associated with three-lettered labels 122 and 124, respectively. Three-lettered label 122, which is designated USL, represents an upper specification limit; and three-lettered label 124, which is designated LSL, represents a lower specification limit.

Specification limits represent boundaries between favorable and unfavorable values for the output variable and can be set in a variety of fashions.

Referring now to FIG. 4b, there is seen inside of “classically”-shaped bell curve 120, a number of smaller, narrower-shaped curves 117,118 and 119, each of which represents the actual output responses associated with a vector of A or B or C values for the input variables corresponding to bars 81-86. For example, curve 117 is associated with the vector BACCCA for the input variables 81-86. Curves 117, 118 and 119 represent three of many possible curves each associated with a particular vector of the input values.

(c)Optimization of doses using APC techniques.

This involves analysis of patterns of input data for specific population subgroups and identification of dosage levels (and other controllable variables) that are associated with the achievement of targeted safe and efficacious medical outcomes for each population subgroup. In the analysis of blood serum lab results, POEM will identify particular patterns of blood test results (“signatures”) that play a key role in identifying preferred doses for particular subgroups.

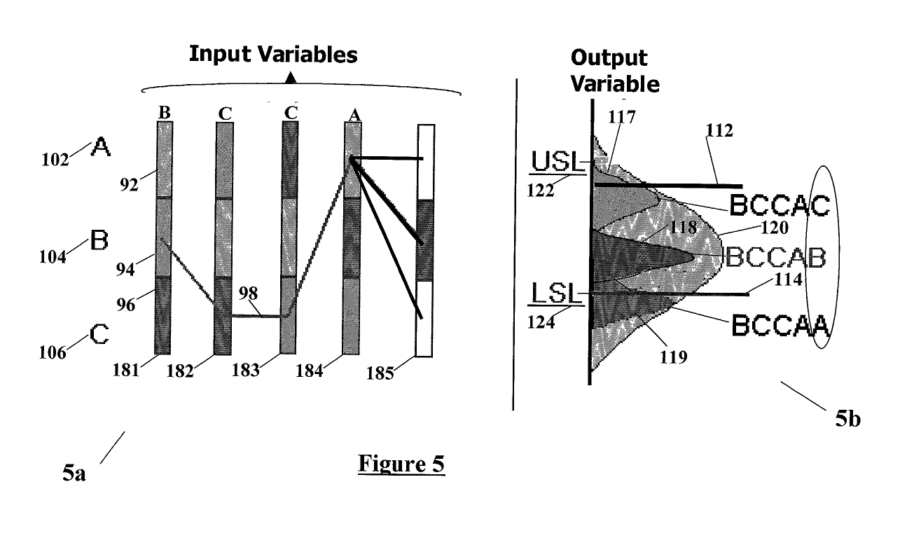

A preferred embodiment of the present invention is implemented by a computer that is programmed for the optimization of dosages for various segments of the population as illustrated in FIG. 5. A computer program first maps the complex process determining drug safety and efficacy. This is done with the help of persons with expert knowledge about the process, and the mapping is characterized by breaking the full process into several smaller interrelated processes or models, each with a manageable number of input and output variables. The map, called a Knowledge Tree, identifies input variables for which data are to be collected in order to predict the values of defined output variables measuring drug safety and efficacy. One of the input variables is the drug dosage given to patients. The list of variables for which data are to be collected may include variables not now collected in the prior art or collected with lesser frequency than recommended in the method. For example, it may be recommended that certain standard blood test results be monitored more frequently than is currently done and certain additional blood tests be undertaken which are now not undertaken.

Analysis of the data is undertaken using POEM, which looks at many population segments separately. POEM employs discretization, in which the values for continuous variables are grouped, where each discrete group is defined by a letter “A” 92, “B” 94, “C” 96, etc. or a label such as “high”, “medium”, “low”. The number of discrete groups shown in this example as three groups should not be seen as limiting in any way and may be more or less as the method demands.

Each population segment is defined by a vector 98 of input variable values that includes the dosage of the drug 185 and other input variables such as age 181, sex 182, body mass index 183 , and blood test results 184, blood pressure (not shown), etc. The dosage 185 of the drug may have three different dose levels “A” 92, “B” 94, “C” 96, or “high”, “medium”, or “low”). An example of an input vector would be “male patients over the age of 60 having “medium” body mass index and a “high” cholesterol level, taking a “high” dosage of the drug.” Associated with this vector 98 is an average value and measure of variability for relevant output variables related to the drug's safety and efficacy.

As illustrated by vector 98 three different dosage levels 185 (A, B, C, or “high”, “medium”, or “low”) are given to patients with the same values for other input variables age 181, sex 182, body mass index 183, and blood test results 184. The combination of these other input values 181-184 and dose A constitutes one population segment represented by curve BCCAA 119 in FIG. 5b, the combination of these other input values and dose B represents second population segment BCCAB 118 in FIG. 5b, and the combination of these input values and dose C represents a third distinct population segment BCCAC 117 in FIG. 5b. By the computer program determining how the safety and efficacy output values varies for these three population segments, the computer program identifies the preferred dosage for patients with the given other input variables (age, sex, body mass index, blood test results, etc.) Repeating this process for other combinations of the age, sex, body mass index, blood test results, etc. variables enables the computer program to generate a recommended dosage for each specific combination of these other input variables.

Referring now to FIG. 5b, there is seen inside of “classically”-shaped bell curve 120, which is the distribution for all input combinations, three smaller, narrower-shaped curves, which represent the actual output responses associated with the input vectors represented by letter combinations BCCAA 119, BCCAB 118 and BCCAC 117.

Because at least some of the output values in the curve BCCAA 119 lie below the lower specification limit (LSL) 124, and at least some of the output values in the curve BCCAC 117 lie above the higher specification (USL) 122, representing unfavorable outcomes, the distribution BCCAB lies entirely within the range between the lower and upper specification limit, which therefore makes B the optimal dosage for this population segment.

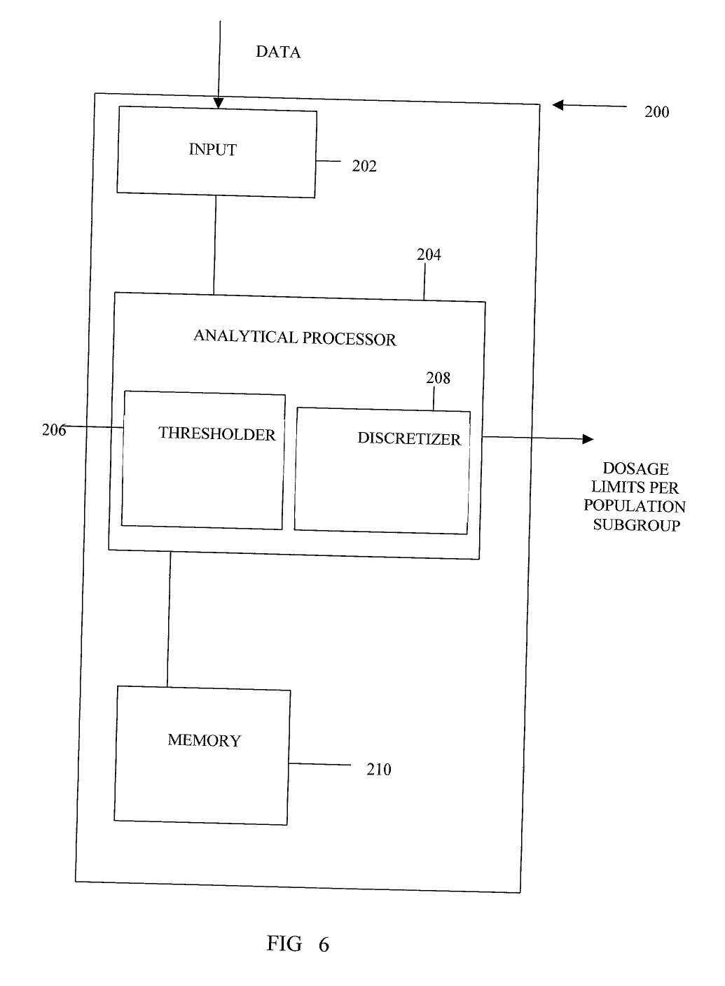

Reference is now made to FIG. 6, which is a simplified block diagram showing apparatus 200 for reducing a probability of a negative outcome of application over a population, of a pharmaceutically active product. That is to say the apparatus considers effects of treatment of a product over a population in order to reduce, or at least quantify, the chances of a negative outcome over a population or part thereof.

The apparatus preferably comprises an input 202 for receiving data including dosage and corresponding results data of the application, which is to say it preferably receives data that includes dosage levels and corresponding outcomes for individuals within the treatment population. The data may also include equivalent information for similar products. For example in using the apparatus to determine safe dosage limits for a new drug for reducing cholesterol levels, it may be relevant to consider usage data for other, existing drugs that treat high cholesterol levels. Likewise, additional data may be taken into account concerning the type of population or population subgroup under test. As a trivial example, a certain percentage death rate may be recorded following application of the drug to a highly obese subgroup of a population over the age of 70. To be meaningful the death rate is preferably compared to the overall death rate for that highly obese subgroup.

The apparatus further comprises an analytical processor 204 which analytically processes the data. The analysis preferably comprises determining relationships between dosage data and individual outcomes of the drug application and for various population subgroups. Such an analysis, may for example show that a given dosage is dangerous over the population as a whole but is actually entirely safe for the subgroup of men between the ages of 20 and 30. The analysis may be used to arrive at safe but nonetheless efficacious dosage recommendations for the pharmaceutically active product in question for various of the identified subgroupings. Preferably, the safe dosage level recommendations that are arrived at minimize the probability of a negative outcome of use of the product over the population as a whole.

The analytical processor 204 preferably comprises a thresholder 206 for setting a probability threshold for selecting a safe dosage recommendation. Different drugs may use different thresholds, for example depending on the severity level of a given side effect as compared with the danger to the patient from the condition that the drug is intended to treat.

Preferably, the probability threshold is an actuarially valid or verifiable probability threshold.

There are a range of techniques that may be used together or separately by the analytic processor 204. One such technique is the knowledge tree. As described above, the knowledge tree preferably includes interconnection cells describing qualitative relationships between inputs and outputs, and then uses incoming data to apply a quantitative model to the relationships.

Another technique is the POEM technique described above in which data ranges are discretized, by discretizer 208, to form a discrete vector model. The discrete vector model approach is particularly useful for identifying useful population subgroupings. The subgroupings are simply represented as respective discrete vectors within the POEM model structure.

In addition any kind of decision making optimization technique may be used.

A memory unit 210, preferably holds data associated with the product. The data held may include data on which the dosage recommendations have been based, or even ownership information and ownership registration infonnation. Holding of such information may for example facilitate ownership transfer in case of occurrence of said negative outcome.

The result of use of the above apparatus, typically embodied as a software system, is preferably a dosing regime characterized by a set of different recommended doses for particular population segments, wherein the associated safety and efficacy outcomes are expected to be better than would be obtained with a more uniform dosing regime, of the kind typical with the prior art. By reducing the occurrence of adverse drug effects, the drug has a higher probability of receiving regulatory approval and, after it is introduced to the market, has a lower probability of causing adverse effects that would lead to its withdrawal or to a significant narrowing of its user population.

These techniques preferably enable population subgroups to be defined such that customized dosages—including possibly zero doses [i.e. excluding the subgroup from the user population of the drug]—an be computed for each such subgroup to achieve improved efficacy results and reduced occurrence of potentially adverse drug effects.

Based on the results of these techniques, the pharmaceutical company may face two options in submitting the drug for FDA approval, each with a different implication regarding the extent of insurance coverage:

The first option for the pharmaceutical company action is to propose the drug with specific dosages for particular population subgroups and exclusions of certain other population subgroups from use of the drug (if indicated by the findings). This could lead to the insurance company offering more favorable conditions to the pharmaceutical company such as insurance being subject to a standard deductible (Example: 30% of Phase III trial costs).

A second option for the pharmaceutical company action is to propose the drug to the regulatory authorities not in accordance with the method's findings but rather according to the continued use of “prior art” approach of one or only a few dosages. This could lead to insurance being subjected to an enlarged deductible. (Example: 60% of Phase III trial costs.) The insurance company would require a higher deductible in this case because of greater perceived risk that the drug would be rejected by the regulatory authorities.

A pharmaceutical company seeking to insure against the risk of adverse side effects emerging after a drug is in the market may thus be required to submit its request for regulatory approval of one or more possible dosing regimes, including one regime in which there are different doses for different, specific population subgroups.

The pharmaceutical company may choose, in addition, to submit a conventional dosing regime (a single dose, or small number of doses)—the typical approach according to the prior art as illustrated in FIG. 1.

Effective, easy-to-use implementation of the method after the drug is in the market will require a software program, that would customize the dose for each patient based on the patient's characteristics (including serum data) and which population subgroup he/she belongs to. It would also require effective ways of incorporating the program into existing workflows.

As a condition of post-approval insurance against the risk of withdrawal or significant narrowing of the user population, the pharmaceutical company will accept four insurer requirements:

(a)Regular lab tests of patient serum levels to be taken from patients receiving the drug;

(b)Monitoring of all Phase IV safety-monitoring results, included the serum lab data, by an external service provider appointed for that purpose by the insurer;

(c)Physicians prescribing the drug are to be informed of the results of a prescription dosage recommendation system to be operated by participating labs. The system may recommend a dose based on patient-specific data (including the patient's serum lab data) as part of the lab report of the serum data; and

(d)All of the IP rights and relevant data associated with the drug may be organized in readily transferable form and then transferred in the case that an insurable event occurs.

Within such an insurance approach, the goal of the prescription dosage recommendation system is to reduce the incidence of adverse effects of the drug. The system may be based on analysis of an accumulating database of Phase IV results, as well as earlier data and is preferably updated from time to time to reflect new data. This process of updating is known as feedback.

By being able to detect significant patterns among finely defined segments of the population, the system's recommendations may result in doctors avoiding doses that either might otherwise be dangerous in specific patients or might be non-efficacious.

As part of the insurance policy, all relevant data in addition to all other rights such as intellectual property rights associated with a rejected or withdrawn or significantly-narrowed-user-population drug are preferably transferred in a readily transferable form to the insurance company (or to an entity of its choosing). This will enable improved residual value of failed drugs though remarketing, following regulatory approval based on using a greater number of doses tailored to specific population subgroups. The transferring pharmaceutical company may provide adequate staff person-years needed to facilitate the transfer of data and IP related to the rejected/withdrawn/significantly user-population narrowed drug to the receiving entity.

The receiving entity, using the analytic tools that are part of the method, would analyze the clinical trials data and/or Phase IV data in order to determine modified doses for different population segments that would be expected to avoid adverse drug impacts. Following approval of new dosages by the regulatory authorities, marketing of the drug would resume. The transfer of the rights to a rejected or withdrawn or significantly-narrowed-user-population drug to the insurance company, combined with the salvage of additional revenues from the re-marketing of the drug, would further improve the economic viability of the proposed insurance.

The present embodiments show four principle differences over the prior art: First, the present method adds lab test data including blood serum data; second, the method adds historical databases of such lab test data and other data that is currently included in prior art methods; third, the method adds analytic techniques that facilitates analysis of population segments; and fourth, recommendations for use of the drug are not constrained to proposing a single dosage for all users (or perhaps a few variations of the standard dose), but rather allow fme delineations of recommended doses for various population subgroups.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method of reducing a probability of a negative outcome of application over a population, of a pharmaceutically active product, the method comprising:
obtaining data including dosage data and result data of said application, and
analytically processing said data to relate dosage data to subgroupings within said population, thereby to arrive at a safe and efficacious dosage recommendation of said pharmaceutically active product for at least one of said subgroupings, said safe dosage level recommendation being arrived at to minimize said probability of a negative outcome.

2. The method of claim 1, wherein said obtaining data comprises obtaining data of standard pharmaceutical product tests.

3. The method of claim 1, wherein said obtaining data comprises obtaining data of non-standard pharmaceutical product tests.

4. The method of claim 1, wherein said obtaining data comprises obtaining historical use data of said product.

5. The method of claim 1, wherein said obtaining data comprises obtaining historical data of other pharmaceutically active products similar to said product.

6. The method of claim 1, wherein said obtaining data comprises obtaining data of respective population subgroupings.

7. The method of claim 1, comprising providing dosage recommendations respectively for a plurality of said population subgroupings.

8. The method of claim 1, wherein said obtaining data comprises monitoring blood serum levels of members of said population.

9. The method of claim 1, comprising using a probability threshold to select said safe dosage recommendation.

10. The method of claim 1, wherein said probability threshold is an actuarially verifiable probability threshold.

11. The method of claim 1, wherein said analytically processing comprises use of at least one technique selected from the group consisting of:
a knowledge tree, said knowledge tree including interconnection cells describing qualitative and quantitative relationships between inputs and outputs,
a discrete vector model, and
a decision making optimization technique.

12. The method of claim 1, wherein said analytically processing comprises using discrete vectorization modeling to analyze said population into said population subgroupings.

13. The method of claim 12, wherein said discrete vectorization modeling comprises representing said subgroupings as respective vectors within a discrete vector analytical model.

14. A method of reducing a probability of a negative outcome of application, over a population, of a pharmaceutically active product, the method comprising:
obtaining data including dosage data and results data of said application, and
analytically processing said data to relate dosage data to subgroupings within said population, thereby to arrive at an actuarially robust safe and efficacious dosage recommendation of said pharmaceutically active product for at least one of said subgroupings, said safe dosage level recommendation being arrived at to minimize said probability of a negative outcome.

15. The method of claim 14, wherein said analytically processing comprises use of at least one technique selected from the group consisting of:
a knowledge tree, said knowledge tree including interconnection cells describing qualitative and quantitative relationships between inputs and outputs,
a discrete vector model, and
a decision making optimization technique.

16. The method of claim 11, wherein said analytically processing comprises using discrete vectorization modeling to analyze said population into said population subgroupings.

17. Apparatus for reducing a probability of a negative outcome of application over a population, of a pharmaceutically active product, the apparatus comprising:
an input for receiving data including dosage and corresponding results data of said application, and
an analytical processor for analytically processing said data to relate dosage data to subgroupings within said population, thereby to arrive at a safe and efficacious dosage recommendation of said pharmaceutically active product for at least one of said subgroupings, said safe dosage level recommendation being arrived at to minimize said probability of a negative outcome.

18. The apparatus of claim 17, wherein said analytical processor is further operable to provide dosage recommendations respectively for a plurality of said population subgroupings.

19. The apparatus of claim 17, wherein said analytical processor comprises a thresholder to obtain a probability threshold to select said safe dosage recommendation.

20. The apparatus of claim 19, wherein said probability threshold is an actuarially verifiable probability threshold.

21. The apparatus of claim 17, wherein said analytical processor is adapted to use at least one technique selected from the group consisting of:
a knowledge tree, said knowledge tree including interconnection cells describing qualitative and quantitative relationships between inputs and outputs,
a discrete vector model, and
a decision making optimization technique.

22. The apparatus of claim 17, wherein said analytical processor comprises a discretization modeler to analyze said population into said population subgroupings.

23. The apparatus of claim 22, wherein said discretization modeler is operable to represent said subgroupings as respective vectors within a discrete vector analytical model.

24. The apparatus of claim 17, further comprising a memory unit for registering ownership information relating to said active pharmaceutical product, thereby to facilitate ownership transfer in case of occurrence of said negative outcome.
